(19) United States
(12) Patent Application Publication
(10) Pub. No.: US 2022/0166840 A1
(43) Pub. Date: May 26, 2022

(54) PRESENTATION DEVICE, PRESENTATION METHOD, AND PRESENTATION PROGRAM

(71) Applicant: NIPPON TELEGRAPH AND TELEPHONE CORPORATION, Tokyo (JP)

(72) Inventors: Miho IKEDA, Musashino-shi, Tokyo (JP); Naoko KOSAKA, Musashino-shi, Tokyo (JP); Tomohiro KOKOGAWA, Musashino-shi, Tokyo (JP)

(73) Assignee: NIPPON TELEGRAPH AND TELEPHONE CORPORATION, Tokyo (JP)

(21) Appl. No.: 17/441,699

(22) PCT Filed: Mar. 10, 2020
(86) PCT No.: PCT/JP2020/010222

§ 371 Date: Sep. 22, 2021

(30) Foreign Application Priority Data
Mar. 25, 2019 (JP) 2019-056696

(51) Int. Cl. H04L 67/51; G06Q 10/06

(52) U.S. Cl. CPC H04L 67/16; G06Q 10/0635

(57) ABSTRACT

A storage unit stores a service support system and a service function constituting the service support system in association with each other, and stores a target restoration level at the time of a failure of the service support system, an achievement determination criterion defined using the service function to determine that the target restoration level has been reached, and an implementation item constituting a countermeasure for realizing the target restoration level in association with each other. A determination section determines whether the service support system is functioning normally, by using failure information of the service support system, and when it is determined that the service support system is not functioning normally, a specifying section refers to the storage unit and specifies a target restoration level corresponding to the achievement determination criterion corresponding to a service function concerning the failure information, from the target restoration levels of the business.

### TECHNICAL FIELD

The present invention relates to a presentation device, a presentation method, and a presentation program.

### BACKGROUND ART

Organizations such as companies and government offices use one or more IT systems to improve service efficiency. When an incident of an IT system failure occurs due to program bugs, device malfunction, or cyberattacks, the service using such an IT system is forced to be delayed or stopped, which affects the entire business. In preparation for such a situation, a formulation of a business continuity plan is recommended to analyze and evaluate effects of an incident and prepare preventive measures of the incident and countermeasures at the time of incident occurrence in advance (see Non-Patent Literature 1).

Conventionally, the formulation of a business continuity plan has been performed by a procedure of formulating a basic policy, analyzing and evaluating the degree of business effect and risk, and examining a business continuity strategy and countermeasures. The analysis of the degree of business effect is performed by a procedure of evaluating the degree of effect due to business interruption, narrowing down an important service that should be continued and restored preferentially based on the result, setting a target restoration time and a target restoration level, and grasping important elements that are indispensable for the implementation of each important service to extracting a bottleneck.

In addition, the analysis of risk is performed by a procedure of finding out occurrence events that may cause business interruption, evaluating the possibility of occurrence of these events and the degree of effect when the events occur, narrowing down the occurrence events that should be handled preferentially, examining damage of the important service, which is narrowed down by the analysis of the degree of business effect, caused by the occurrence events, and estimating a target restoration time and a target restoration level.

In order to effectively formulate countermeasures at the time of incident occurrence according to these procedures, it is necessary to accurately grasp the situation of damage caused by the incident and appropriately select countermeasures for the damage situation when the incident occurrence occurs.

### CITATION LIST

### Non-Patent Literature

Non-Patent Literature 1: “Business Continuity Guidelines-Strategy and Countermeasures to Overcome Any Crisis Event-”, [online], August, 2013, Minister of State for Disaster Management, [Search on Feb. 27, 2019], Internet site <URL: http://www.bousai.go.jp/kyoiku/kigyou/pdf/guideline03.pdf>

### SUMMARY OF THE INVENTION

### Technical Problem

However, according to the conventional technique, it may in some cases be difficult to appropriately select countermeasures at the time of incident occurrence. For example, damage caused by the incident occurs at multiple locations at the same time, and the damage situation changes with an elapse of time. Therefore, it is not easy for a person to accurately perform very advanced information processing in which information on the damage caused by the incident is collected, the overall picture of the damage caused by the incident is comprehensively grasped based on such information, and an appropriate countermeasure is selected. According to the person, even when the overall picture of the damage caused by the incident can be comprehensively grasped, an erroneous countermeasure may be selected mistakenly.

An object of the present invention, which has been made in view of the above circumstances, is to enable appropriate selection of a countermeasure at the time of incident occurrence.

### Means for Solving the Problem

In order to solve the above problems and achieve the object, a presentation device according to the present invention includes: a storage unit that stores a service support system used in business and a service function constituting the service support system in association with each other, and stores a target restoration level of the business at the time of a failure of the service support system, an achievement determination criterion defined using the service function to determine that the target restoration level has been reached, and an implementation item constituting a countermeasure for realizing the target restoration level in association with each other; a determination section that determines whether the service support system is functioning normally, by using failure information of the service support system; a specifying section that, when it is determined that the service support system is not functioning normally, refers to the target restoration level and the achievement determination criterion stored in the storage unit, and specifies a target restoration level corresponding to the achievement determination criterion corresponding to a service function concerning the failure information, from the target restoration levels; and a selection section that refers to the storage unit and selects an implementation item corresponding to the specified target restoration level.

### Effects of the Invention

According to the present invention, it is possible to appropriately select a countermeasure at the time of incident occurrence.

### BRIEF DESCRIPTION OF DRAWINGS

FIG. 1 is a schematic diagram illustrating a schematic configuration of a system including a presentation device of an embodiment.

FIG. 2 is a diagram illustrating business related information.

FIG. 3 is a diagram illustrating service support system related information.

FIG. 4 is a diagram illustrating a business continuity plan.

FIG. 5 is a diagram illustrating emergency correspondence related information.

FIG. 6 is a diagram showing a screen display example of a selection result.

FIG. 7 is a flowchart showing a presentation processing procedure.

FIG. 8 is a diagram showing an example of a computer that executes a presentation program.

### DESCRIPTION OF EMBODIMENT

An embodiment of the present invention will be described below in detail with reference to the drawings. The present invention is not limited to the embodiment. In the description of the drawings, the same components are denoted by the same reference numerals.

### [Configuration of System]

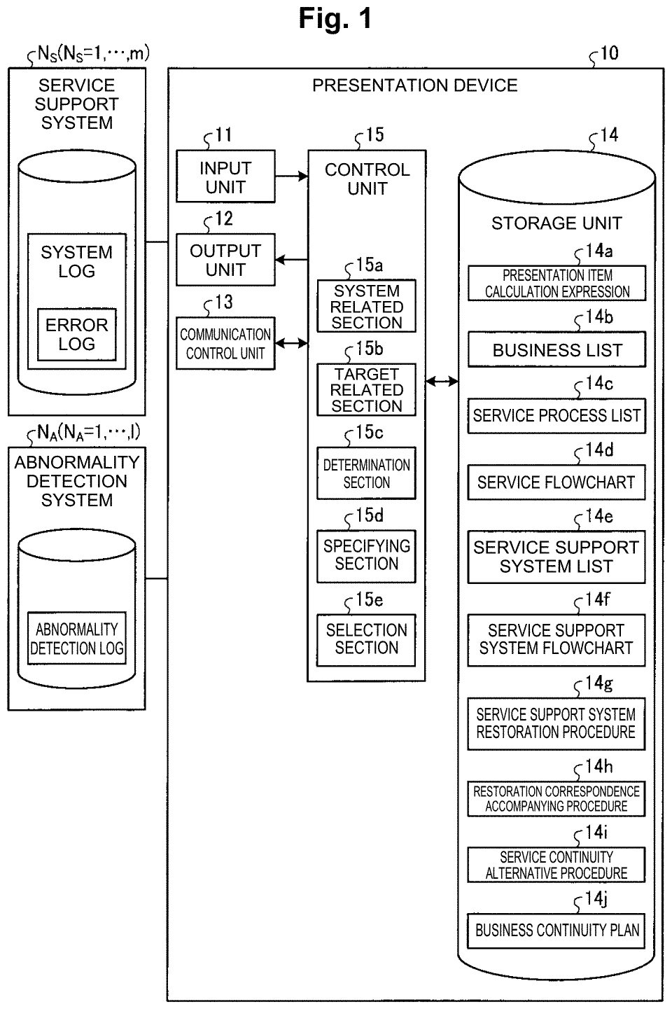

FIG. 1 is a schematic diagram illustrating a schematic configuration of a system including a presentation device of the present embodiment. As illustrated in FIG. 1, a presentation device 10 of the present embodiment performs presentation processing described below using information of a plurality of service support systems N_{S} (N_{S}=1, . . . , m) and a plurality of abnormality detection systems N_{A} (N_{A}=1, . . . , l). Here, m and 1 may be same or different numerical values.

The service support system N_{S} is an IT system used to carry out service in an organization that performs business. Each of the service support system N_{S} stores a system log and an error log. The system log indicates an operation history of the service support system N_{S}. The system log includes an error log. The error log includes failure information indicating which of service functions of the service support system N_{S} is in an abnormal status when an abnormality occurs. In presentation processing to be described below, a system log including failure information may be used instead of the error log.

The abnormality detection system N_{A} is a system used to detect abnormalities in the service support system N_{S}. One or more abnormality detection systems N_{A} are present corresponding to one or more service support systems N_{S}. Each of the abnormality detection systems N_{A} stores an abnormality detection log, which is a history when an abnormality is detected in each target service support system N_{S}. The abnormality detection log includes failure information indicating which of service functions of the target service support system N_{S} is in an abnormal. In the presentation processing to be described below, the presentation device 10 determines normality of the service support system N_{S} using the failure information.

### [Configuration of Presentation Device]

As illustrated in FIG. 1, the presentation device 10 is realized by a general-purpose computer such as a personal computer, and includes an input unit 11, an output unit 12, a communication control unit 13, a storage unit 14, and a control unit 15.

The input unit 11 is realized using an input device such as a keyboard or a mouse, and input various types of instruction information such as a start of processing to the control unit 15 in response to an input operation from an operator. The output unit 12 is realized by a display device such as a liquid crystal display or a printing device such as a printer. For example, the output unit 12 display results of the presentation processing to be described below.

The communication control unit 13 is realized by an NIC (Network Interface Card), and controls communication between an external device and the control unit 15 via a telecommunication line such as a LAN (Local Area Network) or the Internet. For example, the communication control unit 13 controls communication between the control unit 15 and the service support system N_{S}, the abnormality detection system N_{A}, or the management device that manages various types of information on the business, the service, and the service support system N_{S} used for the presentation processing to be described below.

The storage unit 14 is realized by a semiconductor memory element such as a RAM (Random Access Memory) or a flash memory or a storage device such as a hard disk or an optical disk. The storage unit 14 may be configured to communicate with the control unit 15 via the communication control unit 13.

In the present embodiment, the storage unit 14 stores a service support system used in business and a service function constituting the service support system in association with each other. The storage unit 14 stores a target restoration level of the business at the time of a failure of the service support system, an achievement determination criterion defined using the service function to determine that the target restoration level has been reached, and an implementation item constituting a countermeasure for realizing the target restoration level in association with each other. Further, the storage unit 14 stores an implementation item and an implementation procedure constituting the implementation item in association with each other. The implementation procedure includes an accompanying procedure and an alternative procedure.

Specifically, the storage unit 14 stores an implementation item calculation expression 14a, a business list 14b, a service process list 14c, a service flowchart 14d, a service support system list 14e, a service support system flowchart 14f, a service support system restoration procedure 14g, a restoration correspondence accompanying procedure 14h, a service continuity alternative procedure 14i, and a business continuity plan 14j. Prior to presentation processing to be described below, these types of information are collected from the management device that manages various types of information related to the business, the service, and the service support system N_{S} and are stored in the storage unit 14. These types of information are not limited to the case of being stored in the storage unit 14 of the presentation device 10, and may be collected when the presentation processing to be described below is executed, for example.

The implementation item calculation expression 14a includes predetermined relational expressions that define a relation between various types of information used in the presentation processing to be described below. Each of the relational expressions defines functions to be applied and coefficients of the functions.

The business list 14b is a list of a target business in the presentation processing to be described below. In addition, the service process list 14c is information indicating an association between business and a service process constituting the business. Specifically, the service process list 14c is information indicating an association between respective types of business and service process groups constituting the respective types of business and an order relation of respective service processes constituting the respective service process groups.

The service flowchart 14d is information indicating an association between a service process and a service procedure constituting the service process. Specifically, the service flowchart 14d is information indicating an association between service processes and service procedure groups constituting the respective service processes and an order relation of respective service procedures constituting the respective service procedure groups.

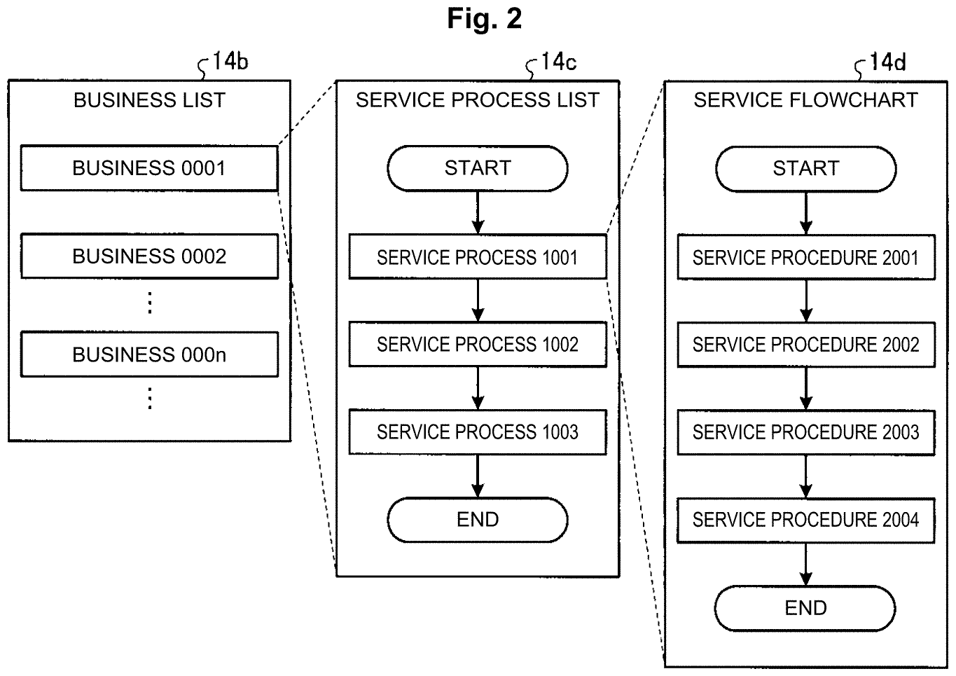

Here, FIG. 2 is a diagram illustrating business related information. The business related information indicates the business list 14b, the service process list 14c, and the service flowchart 14d which are described above. As shown in FIG. 2, the control unit 15 described below can associate the business, the service process group, the service process, the service procedure group, and the service procedure with each other using the business related information.

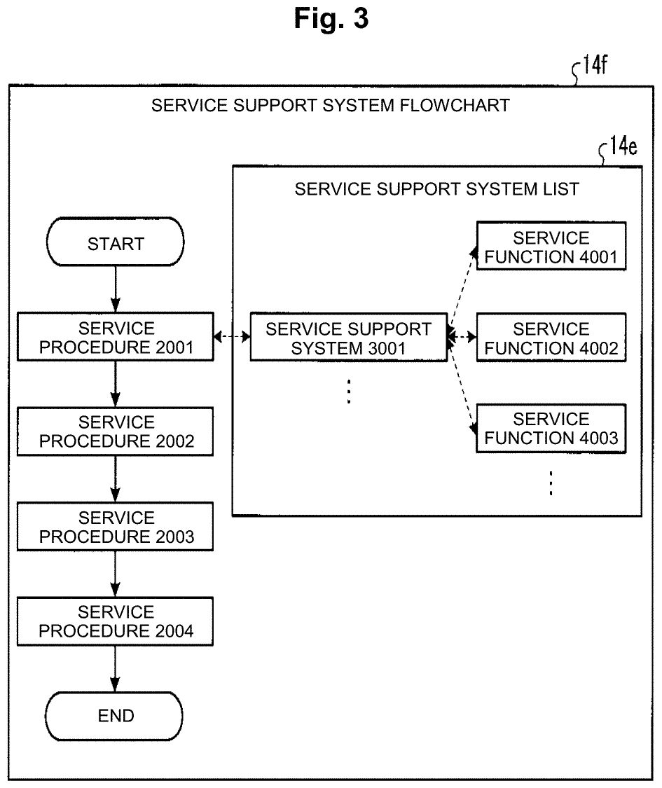

FIG. 3 is a diagram illustrating service support system related information. The service support system related information indicates the service support system list 14e and the service support system flowchart 14f.

The service support system list 14e is information indicating a service support system used in service. Specifically, the service support system list 14e is information indicating an association between service support systems used in respective service procedures and service functions provided by the respective service support system.

The service support system flowchart 14f is information indicating an association between the service procedure and the service support system used in the service procedure and an association between the service procedure and the service functions of the respective service support systems. Specifically, the service support system flowchart 14f is information indicating a list of an association between service procedures and service support systems used in the respective service procedures and an association between the service procedures and service functions of the respective service support systems. In other words, as shown in FIG. 3, the service support system flowchart 14f is information in which the respective service functions of the service flowchart 14d described above is associated with the service support system list 14e.

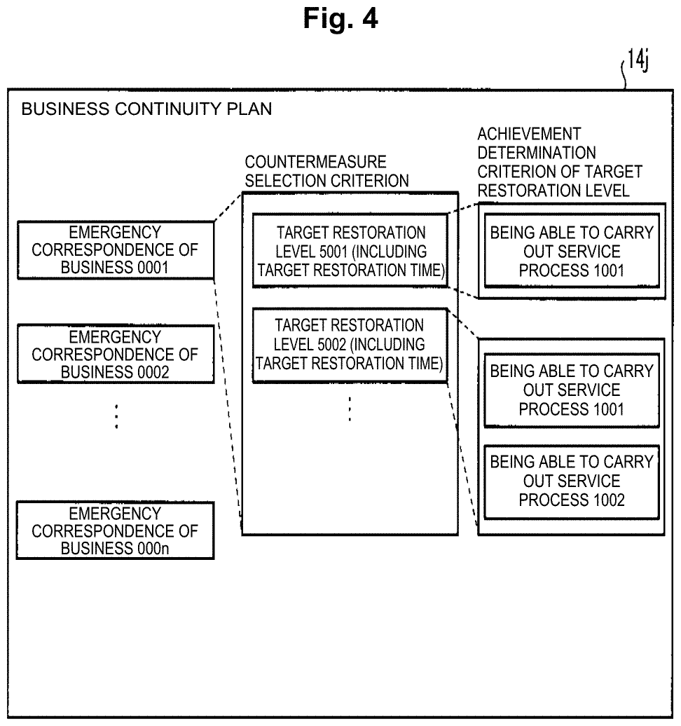

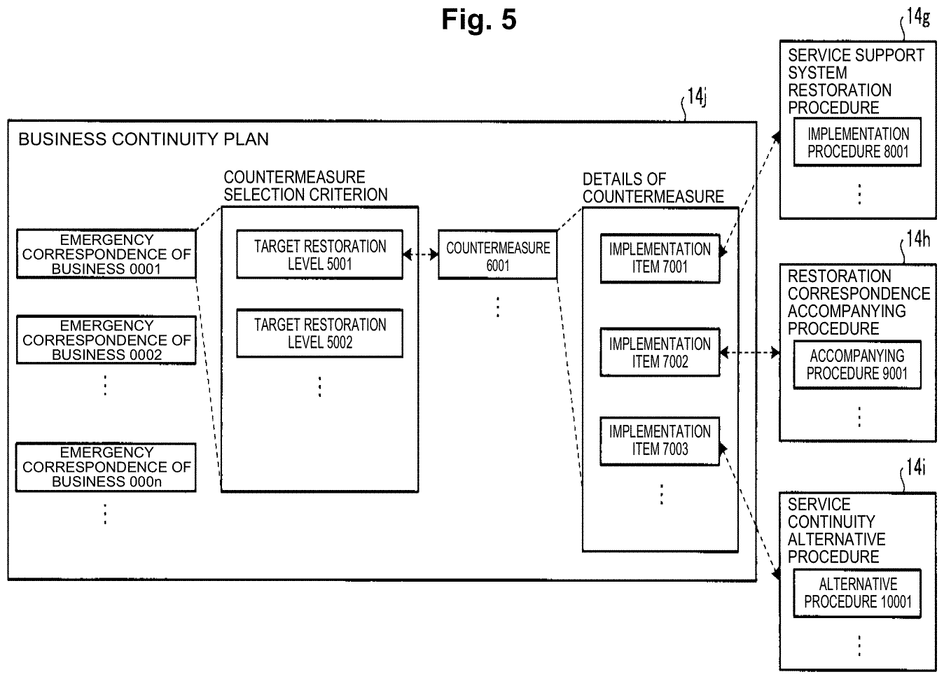

Emergency correspondence related information will be described below with reference to FIGS. 4 and 5. The emergency correspondence related information includes the service support system restoration procedure 14g, the restoration correspondence accompanying procedure 14h, the service continuity alternative procedure 14i, and the business continuity plan 14j. FIG. 4 is a diagram illustrating the business continuity plan 14j. Further, FIG. 5 is a diagram illustrating the emergency correspondence related information.

First, the business continuity plan 14j is information indicating a target restoration level and a target restoration time during an incident occurrence, countermeasures for reaching the target restoration level, and a correspondence system and a correspondence procedure of the department in charge, for each business. Specifically, the business continuity plan 14j includes an association between the business and the target restoration level and the target restoration time of each business, an association between the target restoration level and an achievement determination criterion of each of the target restoration levels, and an association between the target restoration level and countermeasures to achieve each of the target restoration levels.

In other words, as shown in FIG. 4, the business continuity plan 14j includes the association between the business and the target restoration level including the target restoration time of each business. The target restoration level of each business is a selection criterion of emergency countermeasures, and a plurality of target restoration levels may be associated with each business. In the example shown in FIG. 4, for example, a plurality of target restoration levels, for example, a target restoration level 5001, a target restoration level 5002, and so on are associated with business 0001. In addition, absolute or relative priorities are defined to each of the target restoration levels according to the degree of importance of each business.

In addition, the business continuity plan 14j includes the association between the target restoration level of each business and the achievement determination criterion for determining that each target restoration level has been reached. The achievement determination criterion is defined using the service function of the service support system. For example, the achievement determination criterion is defined using the service process or the service procedure corresponding to the service function of the service support system. Each target restoration level may include a plurality of achievement determination criteria. For example, as the target restoration level becomes higher, an item can be added of the achievement determination criteria and a plurality of target restoration levels can be set in stages.

In the example shown in FIG. 4, for example, a target restoration level 5001 of the business 0001 is associated with an achievement determination criterion of “being able to carry out a service process 1001”. In addition, a target restoration level 5002 is associated with two achievement determination criteria of “being able to carry out the service process 1001” and “being able to carry out a service process 1002”. Thus, for example, when the service process 1001 can be carried out but the service process 1002 cannot be carried out, the target restoration level 5001 is achieved, but the target restoration level 5002 is not achieved.

Further, as shown in FIG. 5, the business continuity plan 14j includes an association between a target restoration level of each business and a countermeasure for reaching each target level. Further, in the business continuity plan 14j, each countermeasure is associated with implementation items, as details of the countermeasure, constituting the countermeasure. A plurality of implementation items may be associated with each countermeasure. In the example shown in FIG. 5, the countermeasures 6001 is associated with a plurality of implementation items, for example, an implementation item 7001, an implementation item 7002, an implementation item 7003, and so on. Each of the implementation items may include information indicating a correspondence system of the department in charge.

The service support system restoration procedure 14g includes an implementation procedure indicating an order relation of an operation constituting an implementation item for restoring from an abnormality for each service function of each service support system. The service support system restoration procedure 14g includes an implementation procedure for provisional restoration and an implementation procedure for complete restoration. The service support system restoration procedure 14g includes an estimated time required for each implementation procedure.

When each service function of each service support system does not operate, the restoration correspondence accompanying procedure 14h includes an accompanying procedure indicating an order relation of an operation constituting an implementation item accompanying a restoration operation of the service function. The restoration correspondence accompanying procedure 14h may include a plurality of accompanying procedures, and includes an estimated time required for each accompanying procedure.

When each service function of each service support system does not operate, the service continuity alternative procedure 14i includes an alternative procedure indicating an order relation of an operation that is an alternative means of each service function and constitutes an implementation item for continuing the service function. The service continuity alternative procedure 14i may include a plurality of alternative procedures, and includes an estimated time required for each alternative procedure.

As shown in FIGS. 4 and 5, a control unit 15 to be described below can associate the business, the target restoration level, the service process, the countermeasure, the implementation item, the implementation procedure, the accompanying procedure, and the alternative procedure with each other, by using these types of emergency correspondence related information.

In addition, each of the business list 14b, the service process list 14c, the service flowchart 14d, the service support system list 14e, the service support system list 14e, the service support system flowchart 14f, the service support system restoration procedure 14g, the restoration correspondence accompanying procedure 14h, the service continuity alternative procedure 14i, and the business continuity plan 14j is defined with an element name or an element ID that can be uniquely identified.

Thus, as shown in FIGS. 2 to 5, the control unit 15 can associate the elements of the business, the service process, the service procedure, the service support system, the service function, the target restoration level, the countermeasure, the implementation item, the implementation procedure, the accompanying procedure, and the alternative procedure with each other. Therefore, the control unit 15 can specify other list or flowchart element related to any list or flowchart elements across these list or flowcharts. For example, the control unit 15 can specify all types of business that use a certain service function. Similarly, the service process group constituting the respective types of business and the service procedure group constituting the respective service processes may be defined with element names or element IDs that can be uniquely identified.

Returning to FIG. 1, the description is given. The control unit 15 is realized using a CPU (Central Processing Unit) and executes a processing program stored in a memory. Thus, as illustrated in FIG. 1, the control unit 15 functions as a system related section 15a, a target related section 15b, a determination section 15c, a specifying section 15d, and a selection section 15e. These functional sections may be mounted in different hardware, respectively or in part.

The system related section 15a refers to the storage unit 14 and associates the business with at least one of the service support system and the service function corresponding to the business. In other words, the system related section 15a associates elements of the business, the service process, the service procedure, the service support system, and the service function with each other as shown in FIGS. 2 and 3. The present embodiment is not limited to a case where all of the service support system and the service function are associated with the business, and also includes a case where some of the service support system and the service function are associated with the business.

In addition, various types of information on the implementation item calculation expression 14a, the business list 14b, the service process list 14c, the service flowchart 14d, the service support system list 14e, the service support system flowchart 14f, the service support system restoration procedure 14g, the restoration correspondence accompanying procedure 14h, the service continuity alternative procedure 14i, and the business continuity plan 14j are not limited to a case of being stored in the storage unit 14. For example, the control unit 15 may include a collection section, which collects such types of information, prior to the processing of the system related section 15a.

The target related section 15b refers to the correlation by the system related section 15a and the storage unit 14, and correlates the target restoration level of the business, the implementation item corresponding to the target restoration level, and at least one of the service support system and the service function related to the target restoration level with each other. In addition, the target related section 15b further perform a correlation with the implementation procedure related to the target restoration level. The implementation procedure includes an accompanying procedure and an alternative procedure.

Specifically, as shown in FIG. 4, the target related section 15b associates the target restoration level of each business with the achievement determination criterion of each target restoration level. The target restoration level includes a target restoration time.

As shown in FIG. 5, the target related section 15b associates the target restoration level of each business with the countermeasure of each target level, the implementation item constituting each countermeasure, and the implementation procedure, the accompanying procedure, and the alternative procedure constituting each implementation item.

In this way, the target related section 15b can associate the elements of the target restoration level, the countermeasure, the implementation item, and the implementation procedure/accompanying procedure/alternative procedure with each other. Further, the target related section 15b refers to the business, the service process, the service procedure, the service support system, and the service function associated with each other by the system related section 15a, and can associate the elements of the service function, the service support system, the service procedure, the service process, the achievement determination criterion of the target restoration level, and the target restoration level/target restoration time with each other.

The determination section 15c determines, by using the failure information of the service support system N_{S}, whether the service support system N_{S} is functioning normally. Specifically, the determination section 15c first acquires failure information of the service support system N_{S} from the service support system N_{S} or the abnormality detection system N_{A} via the communication control unit 13.

For example, the determination section 15c acquires failure information of the service support system N_{S} when an error log occurs in the service support system N_{S} or the detection system N_{A} detects an abnormality of the service support system N_{S} at the time of an incident occurrence. The determination section 15c may periodically acquire failure information of the service support system N_{S}. Alternatively, the determination section 15c may acquire failure information of the service support system N_{S} manually input via the input unit 11 at the time of the incident occurrence.

Then, the determination section 15c substitutes the processing result of the target related section 15b and the acquired failure information into a predetermined relational expression of the implementation item calculation expression 14a to determine whether the service support system N_{S} functions normally. Here, functions and coefficients of the functions of the predetermined relational expression used by the determination section 15c are arbitrarily defined. Then, for example, when the failure information of the service support system 3001 includes failure information indicating that a failure has occurred in the service function 4001, the determination section 15c determines that the service support system 3001 is in an abnormal status, that is, is not functioning normally.

When determining that the service support system N_{S} is functioning normally, the determination section 15c ends the presentation processing. On the other hand, when the determination section 15c determines that the service support system N_{S} is not functioning normally, the process proceeds to the specifying section 15d to be described below.

When it is determined that the service support system N_{S} is not functioning normally, the specifying section 15d refers to the target restoration level of the business and the achievement determination criterion stored in the storage unit 14, and specifies a target restoration level corresponding to the achievement determination criterion corresponding to the service function concerning the failure information, from the restoration levels of the business.

Specifically, the specifying section 15d substitutes the processing result of the target related section 15b and the determination result of the determination section 15c into a predetermined relational expression of the implementation item calculation expression 14a to specify a target restoration level that cannot achieve the achievement determination criterion due to the service function corresponding to the failure information. Here, functions and coefficients of the functions of the predetermined relational expression used by the specifying section 15d are arbitrarily defined

For example, in the example shown in FIGS. 2 to 5, the specifying section 15d uses the failure information indicating that a failure has occurred in the service function 4001 of the service support system 3001 to specify that the service procedure 2001 cannot be carried out, as shown in FIG. 3. In this case, the specifying section 15d specifies that the service process 1001 cannot be carried out, as shown in FIG. 2. In addition, the specifying section 15d specifies that the achievement determination criterion of the target restoration level 5001 of “being able to carry out the service process 1001” cannot be achieved, as shown in FIG. 4. In this way, the specifying section 15d specifies the target restoration level 5001 that cannot be achieved due to the failure of the service function 4001 of the service support system 3001.

When a plurality of target restoration levels are set in the business continuity plan 14j in stages, the lower the target restoration level, the smaller the number of items of the achievement determination criteria of the target restoration level and the lower the achievement determination criteria. For example, in the example shown in FIG. 4, the target restoration level 5001 of the business 0001 is associated with the achievement determination criterion of “being able to carry out the service process 1001”. Further, the target restoration level 5002 is associated with two achievement determination criteria of “being able to carry out the service process 1001” and “being able to carry out the service process 1002”.

Thus, for example, when the service process 1001 can be carried out but the service process 1002 cannot be carried out, the target restoration level 5001 is achieved, but the target restoration level 5002 is not achieved. Accordingly, the specifying section 15d specifies the target restoration level 5002. In this way, the specifying section 15d can appropriately specify the target restoration level according to the number of items of the achievement determination criteria that have been achieved.

The selection section 15e refers to the storage unit 14 and selects an implementation item corresponding to the specified target restoration level. In addition, the selection section 15e further selects an implementation procedure, an accompanying procedure, or an alternative procedure corresponding to the specified target restoration level. Further, the selection section 15e further uses the target restoration time included in the target restoration level specified by the specifying section 15d and the estimated time required for the implementation procedure, the accompanying procedure, and the alternative procedure, and selects at least of the implementation item, the implementation procedure, the accompanying procedure, and the alternative procedure.

Specifically, the selection section 15e substitutes the processing result of the target related section 15b and the target restoration level specified by the specifying section 15d into a predetermined relational expression of the implementation item calculation expression 14a to select the implementation item of the countermeasure corresponding to the target restoration level. Here, functions and coefficients of the functions of the predetermined relational expression used by the selection section 15e are arbitrarily defined

Here, the selection section 15e uses the target restoration time included in the target restoration level and the estimated time required for each of the implementation procedure, the accompanying procedure, and the alternative procedure constituting each implementation item, and selects an appropriate implementation item from the plurality of implementation items.

For example, the selection section 15e selects an implementation item for which the estimated time required for the corresponding implementation procedure, accompanying procedure, or alternative procedure is within the target restoration time. The selection section 15e may select a plurality of implementation items. Further, the selection section 15e selects an implementation procedure with a shorter estimated time required when both the estimated time required for the implementation procedure for provisional restoration and the estimated time required for the implementation procedure for complete restoration exceed the target restoration time.

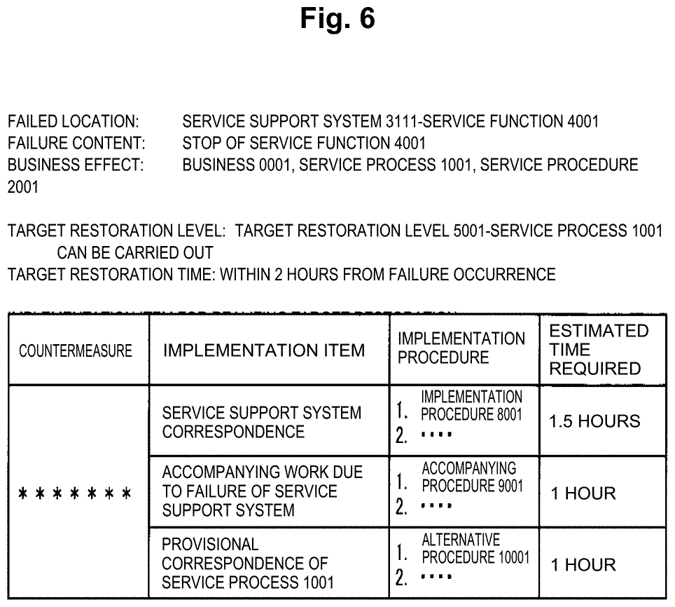

Then, the selection section 15e outputs the selection result in a graph format via the output unit 12. Here, FIG. 6 is a diagram showing an example of screen display of the selection result. In the example shown in FIG. 6, a failed location “service support system 3001-service function 4001” and a failure content “stop of service function 4001” are displayed as the failure information. In addition, the service procedure 2001, the service process 1001, and the business 0001 affected by the failed location are displayed. Further, a specified target restoration level “being able to carry out target restoration level 5001-service process 1001” and a target restoration time “within 2 hours from the failure occurrence” are displayed.

As a result of selection, as a plurality of detailed implementation items of the countermeasure for achieving the target restoration level, a “service support system correspondence”, an “accompanying operation due to service support system failure”, and a “provisional correspondence of service process 1001” are displayed. Detailed implementation procedure, accompanying procedure, or alternative procedure of each implementation item and an estimated time required for each implementation item are displayed. For example, an estimated time required for the implementation item “service support system correspondence” being 1.5 hours and the implementation procedure 8001 are displayed.

Each implementation item can be divided and executed in parallel by each department in charge. Therefore, in the example shown in FIG. 6, when three implementation items are executed in parallel, all the implementation items having the total estimated time required of 3.5 hours can be carried out within 2 hours that are the target restoration time.

In this way, the user of the presentation device 10 can efficiently grasp the countermeasures, the implementation item, and the implementation procedure at the time of incident occurrence. In other words, the presentation device 10 can accurately specify the target restoration level based on the failure information acquired from the service support system or the abnormality detection system or input manually, collect details of the implementation item for achieving the target restoration level, and present it to the user without omission. Thus, the user can prevent an erroneous selection of the correspondence plan without erroneous determination of the target restoration level at the time of incident occurrence, and can grasp the implementation items without omission.

In addition, even when a plurality of incidents occur at the same time, the user can grasp the implementation items constituting the countermeasures at the time of incident occurrence and the details of the implementation items. In other words, even when a failure occurs in one or a plurality of service functions that are components of one business and one or a plurality of service processes or service procedures cannot be carried out, the presentation device 10 carries out the presentation processing based on the achievement determination criteria of the target restoration level. Thus, the presentation device 10 can present the countermeasures for achieving the target restoration level, the implementation items that are details of the countermeasures, the implementation procedures that are details of the implementation items and are used to restore the service support system, and the accompanying procedures accompanying the restoration correspondence or the alternative procedures for service continuity.

The same applies when a failure occurs in one or a plurality of service functions that are components of each business and one or a plurality of service processes or service procedures cannot be carried out. In other words, the presentation device 10 can present, based on the achievement determination criteria of the target restoration level, the countermeasures for achieving the target restoration level, the implementation items, the implementation procedures for restoration of the service support system, and the accompanying procedures accompanying the restoration correspondence or the alternative procedures for service continuity.

For example, when a failure occurs at the same time in the service function 4001 and the service function 4101 used for different service processes of the business 0001, the presentation device 10 carries out the presentation processing based on priorities of the service processes related to the service function 4001 and the service function 4101. In other words, the presentation device 10 can present the target restoration level and the target restoration time for each of the service function 4001 and the service function 4101, the implementation procedure for restoration of the service support system, and the accompanying procedures accompanying the restoration correspondence or the alternative procedures for service continuity.

Thus, even when the target restoration level and the target restoration time of each service function are complicated, for example, it is possible to preferentially present the implementation item to be implemented firstly with a shorter target restoration time.

Further, even when a plurality of incident occurs at the same time and the damage situation changes with the elapse of time, the presentation device 10 carries out the presentation processing based on the priority of each target restoration level and the achievement determination criteria of the target restoration level. Then, the presentation device 10 can arrange and present the countermeasure for achieving the target restoration level and its priority, the implementation item, the implementation procedure for restoration of the service support system, and the accompanying procedures accompanying the restoration correspondence or the alternative procedures for service continuity, in a list format such that the user can easily understand.

The service support system has a redundant configuration, and thus even when a failure occurs in one machine, the service function can be continuously provided with another machine. Even when the business or the service process and the service procedure are not affected, the presentation device 10 can present, by using the failure information of malfunction as a trigger, the countermeasures for achieving the target restoration level, the implementation items that are details of the countermeasures, the implementation procedures that are details of the implementation items and are used to restore the service support system, and the accompanying procedures accompanying the restoration correspondence.

For example, the service support system 3001 and the service support system 3101 have a redundant configuration, and thus when a failure occurs in a hot service support system 3001, the system switches to a standby service support system 3101. In such a case, the presentation device 10 displays that the business, the service process, and the service procedure using the service support system 3001 are not affected. In addition, the presentation device 10 can present the implementation procedure for restoration of the service support system 3001, and the target restoration level and the target restoration time in order to deal with an abnormal situation in which a failure has occurred in the service support system 3001. In such a case, the target restoration level and the target restoration time may be defined in the business continuity plan, an SLA (service level agreement) or an operation manual of the service support system.

According to the presentation device 10, the user can simulate each implementation item corresponding to the stepwise target restoration level at the time of incident occurrence and its details. For example, when the latest target restoration level is “target restoration level 5001 and the next target restoration level after achieving the latest target restoration level is “target restoration level 5002”, it is possible to previously grasp and procure resources necessary for smooth implementation of “target restoration level 5002”. In other words, it is possible to confirm the implementation item at the “target restoration level 5002”, the implementation procedures that are details of the implementation items and are used to restore the service support system, and the accompanying procedures accompanying the restoration correspondence or the alternative procedures for service continuity.

### [Presentation Process]

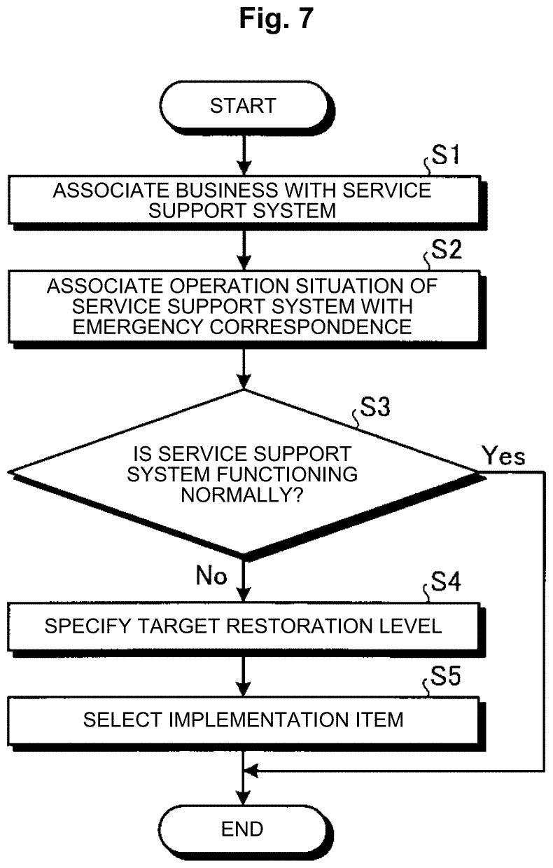

The presentation processing of the presentation device 10 according to the present embodiment will be described below with reference to FIG. 7. FIG. 7 is a flowchart showing a presentation processing procedure. In FIG. 7, the flowchart is started, for example, at the timing when the user inputs an operation to instruct the start.

First, the system related section 15a refers to the storage unit 14 and correlates the business with at least one of the service support system and the service function corresponding to the business. In other words, the system related section 15a associates the respective elements of the business, the service process, the service procedure, the service support system, and the service function with each other as shown in FIGS. 2 and 3 (step S1).

Further, the target related section 15b refers to the correlation by the system related section 15a and the storage unit 14, and correlates the operating situation of the service support system with the emergency correspondence. In other words, the target related section 15b correlates the target restoration level of the business, the implementation item corresponding to the target restoration level, and the service support system or the service function related to the target restoration level. In addition, the target related section 15b correlates the implementation procedure, the accompanying procedure, or the alternative procedure related to the target restoration level with each other (step S2).

Next, the determination section 15c determines whether the service support system N_{S} is functioning normally, by using the failure information of the service support system (step S3). When determining that the service support system is functioning normally (step S3, Yes), the determination section 15c ends a series of presentation processing. On the other hand, when the determination section 15c determines that the service support system N_{S} is not functioning normally (step S3, No), the process proceeds to step S4.

In the process of step S4, the specifying section 15d refers to the target restoration level of the business and the achievement determination criterion stored in the storage unit 14, and specifies a target restoration level corresponding to the achievement determination criterion corresponding to the service function concerning the failure information, from the target restoration levels.

Next, the selection section 15e refers to the storage unit 14, and selects the implementation item corresponding to the specified target restoration level. Further, the selection section 15e selects an implementation procedure, an accompanying procedure, or an alternative procedure corresponding to the specified target restoration level. Further, the selection section 15e further uses the target restoration time included in the target restoration level specified by the specifying section 15d and the estimated time required for the implementation procedure, the accompanying procedure, and the alternative procedure, and selects the implementation item, the implementation procedure, the accompanying procedure, or the alternative procedure (step S5).

Further, the selection section 15e displays and outputs the selection result to the output unit 12 in a graph format. Thus, a series of presentation processing ends.

The respective steps described above may be executed continuously at the time of the incident occurrence, or may be executed separately at different time zones. For example, steps S1 and S2 may be executed at arbitrary timings in ordinal times, and steps S3 to S5 may be executed at the time of the incident occurrence. In such cases, the presentation device 10 may store the results of steps S1 and S2 in the storage unit 14, and read the results from the storage unit 14 at the time of execution of steps S3 to S5.

The above-described presentation processing of the presentation device 10 may be executed for examining countermeasures at the time of the incident occurrence, or may be executed for formulating or modifying a business continuity plan.

As described above, in the presentation device 10 of the present embodiment, the storage unit 14 stores the service support system used in the business and the service function constituting the service support system in association with each other. In addition, the storage unit 14 stores the target restoration level of the business at the time of a failure of the service support system, the achievement determination criterion defined using the service function to determine that the target restoration level has been reached, and the implementation item constituting the countermeasure for realizing the target restoration level in association with each other. In addition, the determination section 15c determines whether the service support system is functioning normally, by using the failure information of the service support system. When it is determined that the service support system is not functioning normally, the specifying section 15d refers to the target restoration levels of the business and the achievement determination criterion stored in the storage unit 14, and specifies a target restoration level corresponding to the achievement determination criterion corresponding to the service function concerning the failure information, from the target restoration levels. The selection section 15e refers to the storage unit 14 and selects an implementation item corresponding to the specified target restoration level.

Thus, the presentation device 10 can accurately specify the target restoration level based on the failure information at the time of incident occurrence, and present the implementation item of the countermeasure for realizing the target restoration level to the user without omission. Accordingly, the user can prevent an erroneous selection of the correspondence plan without erroneous determination of the target restoration level at the time of incident occurrence, and can grasp the implementation items without omission. As described above, according to the presentation device 10, even when a plurality of incidents occur at the same time, it is possible to appropriately select the countermeasures at the time of incident occurrence according to the damage situation and the target restoration level.

In addition, the storage unit 14 further stores the implementation item and the implementation procedure constituting the implementation item in association with each other, and the selection section 15e further selects the implementation procedure corresponding to the specified target restoration level. Specifically, the target restoration level stored in the storage unit 14 includes the target restoration time, the implementation procedure includes the time required for the implementation procedure, and the selection section 15e further uses the target restoration time included in the target restoration level specified by the specifying section 15d and the time required for the implementation procedure to select at least one of the implementation item and the implementation procedure. Thus, the presentation device 10 can present the details of the implementation item.

The implementation procedure includes the accompanying procedure or the alternative procedure. Thus, the presentation device 10 can present various implementation items more specifically.

### [Program]

It is also possible to create a computer program written in a computer executable language, for the process executed by the presentation device 10 described in the embodiment. In one embodiment, the presentation device 10 can be implemented by installing a presentation program that executes the above-described presentation processing as package software or online software on a desired computer. For example, the presentation program is executed by an information processing device, and thus the information processing device can function as the presentation device 10. The information processing device described in the description includes a desktop type or notebook type personal computer. In addition, the information processing device includes smartphones, mobile communication terminals such as mobile phones and PHS (Personal Handyphone System), and slate terminals such as PDA (Personal Digital Assistant). Further, the function of the presentation device 10 may be implemented in a cloud server.

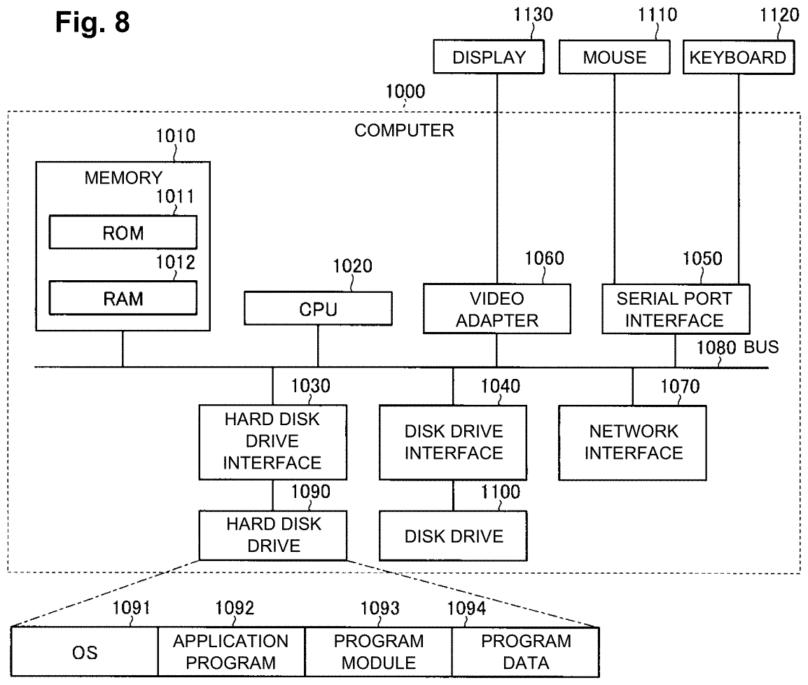

FIG. 8 is a diagram showing an example of a computer that executes a presentation program. The computer 1000 includes, for example, a memory 1010, a CPU 1020, a hard disk drive interface 1030, a disk drive interface 1040, a serial port interface 1050, a video adapter 1060, and a network interface 1070. The respective components are connected to each other via a bus 1080.

The memory 1010 includes a read only memory (ROM) 1011 and a RAM 1012. The ROM 1011 stores therein, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disc and an optical disc is inserted into the disk drive 1100. The serial port interface 1050 is connected to a mouse 1110 and a keyboard 1120, for example. The video adapter 1060 is connected to a display 1130, for example.

In this example, the hard disk drive 1090 stores therein an OS 1091, an application program 1092, a program module 1093, and program data 1094, for example. Each types of information described above embodiment is stored, for example, in the hard disk drive 1090 or a memory 1010.

In addition, the presentation program is stored in the hard disk drive 1090 as, for example, a program module 1093 in which instructions executed by the computer 1000 are described. Specifically, the program module 1093 in which each process executed by the presentation device 10 described in the above embodiments is stored in the hard disk drive 1090.

Data used for information processing by the presentation program is stored as program data 1094 in the hard disk drive 1090, for example. Then, the CPU 1020 reads the program module 1093 and the program data 1094 stored in the hard disk drive 1090 into the RAM 1012 as needed, and executes each of the procedures described above.

The program module 1093 and the program data 1094 related to the presentation program may be stored in a for example, a removable storage medium and read out by the CPU 1020 via the disk drive 1100 without being limited to the case of being stored in the hard disk drive 1090. Alternatively, the program module 1093 and the program data 1094 related to the presentation program may be stored in another computer connected via a network such as LAN or WAN (Wide Area Network), and read out by the CPU 1020 via the network interface 1070.

The embodiment to which the invention devised by the present inventor is applied has been described above. Nevertheless, the present invention is not limited by the description and the drawings that constitute part of the disclosure of the present invention according to the present embodiment. In other words, other embodiments, examples, operational technologies, and the like that are conceived based on the present embodiment by those skilled in the art are all included in the scope of the present invention.

### REFERENCE SIGNS LIST

10 Presentation device
11 Input unit
12 Output unit
13 Communication control unit
14 Storage unit
14a Implementation item calculation expression
14b Business list
14c Service process list
14d Service flowchart
14e Service support system list
14f Service support system flowchart
14g Service support system restoration procedure
14h Restoration correspondence accompanying procedure
14i Service continuity alternative procedure
14j Business continuity plan
15 Control unit
15a System related section
15b Target related section
15c Determination section
15d Specifying section
15e Selection section

1. A presentation device comprising:
a memory that stores a service support system and a service function of the service support system in association with each other, and stores a target restoration level at a time of a failure of the service support system, an achievement determination criterion defined using the service function to determine that the target restoration level has been reached, and an implementation item which is a countermeasure for realizing the target restoration level in association with each other;
determination circuitry that determines whether the service support system is functioning normally, by using failure information of the service support system;
specifying circuitry that, when it is determined that the service support system is not functioning normally, refers to the target restoration level and the achievement determination criterion stored in the memory, and specifies a target restoration level corresponding to the achievement determination criterion corresponding to a service function concerning the failure information, from the target restoration levels; and
selection circuitry that refers to the memory and selects an implementation item corresponding to the specified target restoration level.

2. The presentation device according to claim 1, wherein:
the memory further stores the implementation item and an implementation procedure constituting the implementation item in association with each other, and
the selection circuitry further selects an implementation procedure corresponding to the specified target restoration level.

3. The presentation device according to claim 2, wherein the target restoration level stored in the memory includes a target restoration time, and the implementation procedure includes a time required for the implementation procedure, and
the selection circuitry further uses the target restoration time included in the target restoration level specified by the specifying circuitry and the time required for the implementation procedure to select at least one of the implementation item and the implementation procedure.

4. The presentation device according to claim 2, wherein the implementation procedure includes an accompanying procedure or an alternative procedure.

5. A presentation method to be executed by a presentation device, the presentation device including a memory that stores a service support system and a service function constituting the service support system in association with each other, and stores a target restoration level at the time of a failure of the service support system, an achievement determination criterion defined using the service function to determine that the target restoration level has been reached, and an implementation item constituting a countermeasure for realizing the target restoration level in association with each other,
the presentation method comprising:
determining whether the service support system is functioning normally, by using failure information of the service support system;
when it is determined that the service support system is not functioning normally, referring to the target restoration level and the achievement determination criterion stored in the memory, and specifying a target restoration level corresponding to the achievement determination criterion corresponding to a service function concerning the failure information, from the target restoration levels; and
referring to the memory and selects an implementation item corresponding to the specified target restoration level.

6. A non-transitory computer readable medium including a presentation program which when executed causes a computer to perform:
referring to a memory that stores a service support system and a service function constituting the service support system in association with each other, and stores a target restoration level at the time of a failure of the service support system, an achievement determination criterion defined using the service function to determine that the target restoration level has been reached, and an implementation item constituting a countermeasure for realizing the target restoration level in association with each other, and determining whether the service support system is functioning normally, by using failure information of the service support system;
when it is determined that the service support system is not functioning normally, referring to the target restoration level and the achievement determination criterion stored in the memory, and specifying a target restoration level corresponding to the achievement determination criterion corresponding to a service function concerning the failure information, from the target restoration levels; and
referring to the memory and selects an implementation item corresponding to the specified target restoration level.
